(19) United States
(12) Patent Application Publication
(10) Pub. No.: US 2005/0088741 A1
(43) Pub. Date: Apr. 28, 2005

(54) Security viewing apparatus and method

(76) Inventor: Brian Purser, Stoke-on-Trent (GB)

Correspondence Address: ADAM EVANS, P.A.;(formerly Adams, Schwartz & Evans, P.A.), 2180 TWO WACHOVIA CENTER, CHARLOTTE, NC, 28282, US

(21) Appl. No.: 10/692,651

(22) Filed: Oct. 24, 2003

(51) Int. Cl. G02B 7/00; G02B 25/04

(52) U.S. Cl. 359/504; 359/506

(57) ABSTRACT

A security viewing apparatus for residential or commercial use. The security viewing apparatus has a viewing device and a reflective surface. The viewing device is mounted to the inside of a door and includes an inner vertical tube, an outer vertical tube, a horizontal tube attached to the top of the outer vertical tube, an eyepiece attached to the lower end of the inner vertical tube, and a plurality of lenses and a plurality of reflective devices inside the inner and outer vertical tubes. The reflective surface is mounted to a surface opposite the outside of a door. The reflective surface is convex and has a rectangular shape. When used together, the combination of the viewing device and reflective surface provides an expanded viewing zone of the outside of the door, enhancing the users safety and security.

### TECHNICAL FIELD AND BACKGROUND OF THE INVENTION

This invention relates to a security viewing apparatus for residential or commercial use to provide users with an expanded view of the outside of a door, enhancing the security and safety of the user. Security viewing devices presently take many forms. One such device is a peep hole mounted through a door. While very simple in nature, it does not provide an expanded view of the outside of the door. The peep hole only shows what is standing right in front of it, allowing someone to avoid detection by simply kneeling down or moving to the side. The peep hole has no adjustment for focus or magnification. In addition, the peep hole is not very practical for someone of shorter stature to use due to its non-adjustable nature. Another such device is a camera system. This device provides a detailed and expanded view of the outside of the door, allowing the user to adjust both the focus and magnification. However, the camera system requires expert installation and equipment which is costly to purchase. Also, the camera system requires electrical connections to supply it with electricity. This becomes a problem if there is a power outage unless a generator is used as a back up, thus, creating an additional expense. In addition, the camera system requires periodic maintenance. Accordingly, it would be desirable to have a security viewing apparatus which allows an individual to see an expanded view of the outside of the door, adjust the focus, and adjust the magnification without the expense and complexity of a camera system, while providing a security and safety to the user.

### SUMMARY OF THE INVENTION

Therefore, it is an object of the invention to provide a security viewing apparatus that can be easily installed on a door.

It is another object of the invention to provide a security viewing apparatus that is inexpensive to purchase and easy to install.

It is another object of the invention to provide a security viewing apparatus that provides the user with an expanded view of the outside of the door, enhancing the security and safety of the user.

It is another object of the invention to provide a security viewing apparatus that requires little to no maintenance.

It is another object of the invention to provide a security viewing apparatus that can be used by individuals of different heights.

It is another object of the invention to provide a security viewing apparatus that can be focused.

It is another object of the invention to provide a security viewing apparatus that allows a user to adjust magnification.

These and other objects of the present invention are achieved in the preferred embodiments disclosed below by providing a security viewing apparatus to provide users with an expanded view of a selected area, including a viewing device having a first field of view and a convex reflective surface having a second field of view substantially greater than the first field of view. The reflective surface is positioned in a spaced-apart relationship to the viewing device and within the first field of view so as to reflect a view of the selected area to the viewer.

According to another preferred embodiment of the invention, the viewing device includes a magnification means for adjusting the first field of view with respect to the second field of view produced by the convex reflective surface.

According to another preferred embodiment of the invention, the viewing device includes a means for mounting the viewing device to a vertical surface and the convex reflective surface includes a means for mounting the convex reflective surface to a surface opposite the vertical surface.

According to another preferred embodiment of the invention, the viewing device includes a mounting flange for mounting the viewing device to the vertical surface.

According to another preferred embodiment of the invention, the viewing device includes an inner vertical tube mounted inside of an outer vertical tube for allowing a telescoping adjustment in a vertical direction, a horizontal tube attached to a top end of the outer vertical tube, and an eyepiece attached a lower end of the inner vertical tube for viewing the first field of view.

According to another preferred embodiment of the invention, the inner vertical tube is adjustable in a vertical direction along a central vertical axis of the outer vertical tube for positioning the eyepiece in relation to a user's eye.

According to another preferred embodiment of the invention, the outer vertical tube and the inner vertical tube house a plurality of lenses and a plurality of reflective devices for providing a clear and adjustable first field of view.

According to another preferred embodiment of the invention, the viewing device further comprises an adjustment means cooperating with the plurality of lenses for adjusting a focus and magnification of the viewing device.

According to another preferred embodiment of the invention, the eyepiece includes at least one lens.

According to another preferred embodiment of the invention, the lens is made of glass or plastic.

According to another preferred embodiment of the invention, the plurality of lenses are made of glass or plastic.

According to another preferred embodiment of the invention, the reflective devices are mirrors or prisms.

According to another preferred embodiment of the invention, the horizontal tube includes an objective lens and protrudes through the vertical surface from an inner side of the vertical surface to an outer side of the vertical surface.

According to another preferred embodiment of the invention, the reflective surface has a convex cross-section.

According to another preferred embodiment of the invention, the reflective surface is rectangularly shaped.

According to another preferred embodiment of the invention, the reflective surface is defined as an arc of a sphere having a diameter of eight feet.

According to another preferred embodiment of the invention, the reflective surface is adjustable via an adjustable joint.

According to another preferred embodiment of the invention, the method of installing a security viewing apparatus, includes the steps (a) mounting a viewing device to a vertical surface by sliding a horizontal tube of the viewing device through a hole in the vertical surface and fastening the viewing device to the vertical surface via a mounting means; (b) positioning a reflective surface along a surface opposite an outer side of the vertical surface for receiving a maximum second field of view from the reflective surface when looking through the viewing device; (c) mounting the reflective surface to the surface opposite the outer side of the vertical surface using a mounting means; and (d) adjusting the reflective surface using an adjustable joint to provide a maximum the second field of view.

According to another preferred embodiment of the invention, the method of using a security viewing apparatus, including the steps (a) adjusting an inner vertical tube of a viewing device in a vertical direction for positioning an eyepiece attached to the inner vertical tube in relation to a user's eye; (b) looking through the eyepiece for viewing a first field of view; and (c) adjusting a focus and magnification of the viewing device by a magnification/focus means cooperating with a plurality of lenses to provide a clear first field of view displaying only a second field of view produced by a convex reflective surface.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows a schematic side view of a security viewing apparatus constructed in accordance with the present invention;

FIG. 2 shows a side cross-sectional view of the viewing device attached to a door;

FIG. 3 shows a front view of the viewing device;

FIG. 4 shows a detail view of the reflective surface and adjustable mount;

FIG. 5 shows the eyepiece of the viewing device in registration with an eye;

FIG. 6 shows the reflective surface attached to a wall;

FIG. 7 shows the reflective surface attached to a corner where a wall and ceiling come together;

FIG. 8 shows the angle of vision horizontally of the security viewing apparatus;

FIG. 9 shows the angle of vision vertically of the security viewing apparatus;

FIG. 10 shows the view of the security viewing apparatus near a hallway with a corner;

FIG. 11 shows the view horizontally of the security viewing apparatus in a vestibule or porch;

FIG. 12 shows the view vertically of the security viewing apparatus in a vestibule/porch.

### DESCRIPTION OF THE PREFERRED EMBODIMENT AND BEST MODE

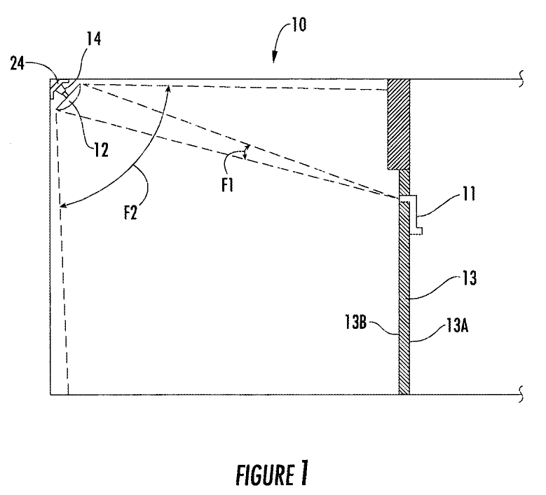

Referring now specifically to the drawings, a security viewing apparatus according to the present invention is illustrated in FIG. 1 and shown generally at reference numeral 10. The particular embodiment shown is a relationship of a viewing device 11 producing a first field of view F1 and a convex reflective surface 12 producing a second field of view F2, which is substantially greater than the first field of view F1. The viewing device 11 and convex reflective surface 12 are positioned in a spaced-apart relationship to provide a view of a selected area outside of a vertical surface 13. The vertical surface could be a door or a wall.

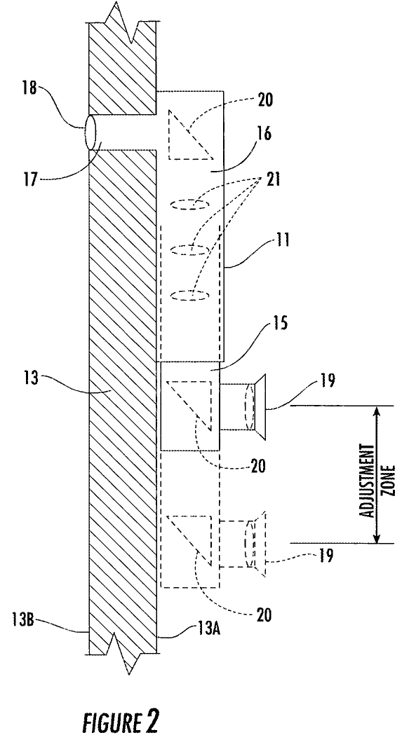

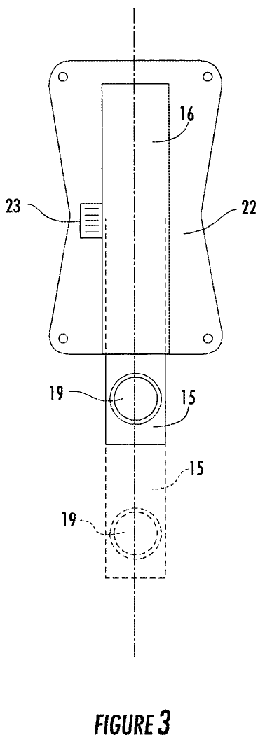

Referring now to FIGS. 2 and 3, the viewing device 11 includes an inner vertical tube 15 mounted inside of an outer vertical tube 16 for allowing a telescopic adjustment in a vertical direction, and a horizontal tube 17 attached to a top end of the outer vertical tube. The inner vertical tube 15 is adjustable in the vertical direction sliding along a central axis of the outer vertical tube 16 for positioning an eyepiece 19 in relation to a user's eye. This allows users of different heights to use the viewing device 11. The outer vertical tube 16 and inner vertical tube 15 house a plurality of lenses 21 and reflective devices 20 to provide a clear and adjustable first field of view F1. The reflective devices 20 can be mirrors or prisms. The lenses 21 can be glass or plastic. The eyepiece 19 comprises at least one lens and is attached to a lower end of the inner vertical tube 15. The lens for the eyepiece 19 can be glass or plastic. The lenses 21 and the reflective devices 20 are adjusted using a magnification/focus means 23 located on the outer vertical tube 16. The magnification/focus means could be an adjustment knob or any other suitable device. The magnification/focus means 23 is connected to an internal mechanism (not shown) to adjust the focus and magnification of the viewing device by changing the focal length and aperture of the lenses 21 in a manner that would be known by a person of ordinary skill in the art. The horizontal tube 17 includes an objective lens 18 and protrudes through the vertical surface 13 from the inner side 13A of the vertical surface 13 to the outer side 13B of the vertical surface 13 in the same manner that a peep hole would be installed. The viewing device 11 is attached to the inner side 13A of the vertical surface 13 by sliding the horizontal tube 17 through an existing/new hole in the vertical surface 13 and then fastening the viewing device 11 to the inner side 13A of the vertical surface 13 by a mounting means 22 such as a mounting flange or any other suitable mounting device.

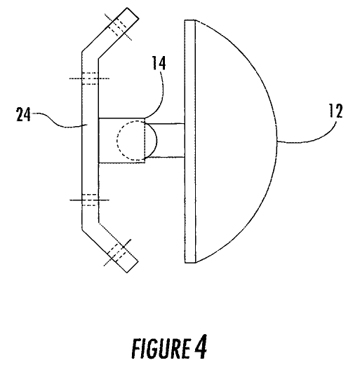

Referring now to FIG. 4, the convex reflective surface 12 is rectangular and has a convex cross-section. The convexity of the mirror is defined as an arc of a sphere having a diameter of eight feet. However, any shape which provides a desired field of vision may be used. The convex reflective surface 12 can be a conventional mirror or any suitable surface for providing a clear reflection. The convex reflective surface 12 is positioned between the ceiling and floor opposite the vertical surface 13 in relationship with the viewing device 11 to provide a maximum second field of view F2, and attached to a surface, such as a wall, using a mounting means 24 with an adjustable joint 14 such as a ball and socket device. The adjustable joint 14 allows the convex reflective surface 12 to be adjusted to provide a maximum second field of view. The mounting means 24 could be a mounting bracket or any other suitable device which allows the convex reflective surface 12 to be mounted in a variety of positions and locations.

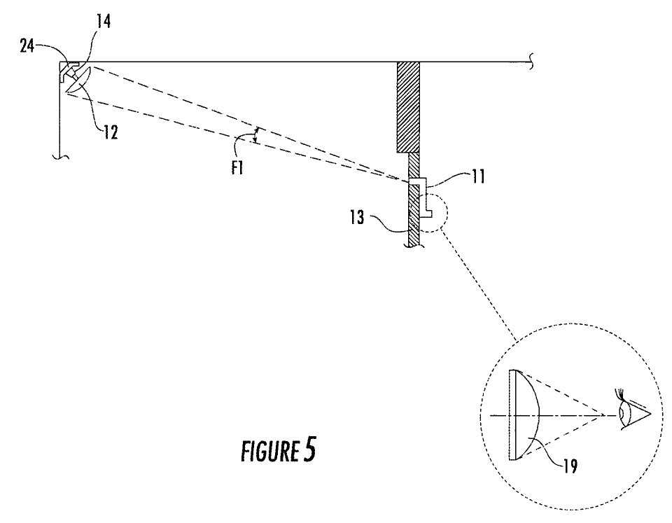

Referring now to FIG. 5 the viewing device 11 produces a wide angle, magnified view of a selected area over a short distance making it distinct from binoculars or a periscope. The viewing device 11 focuses the image on the convex reflective surface 12 to a focal point close to the eye, eliminating the distance between the eyepiece and the convex reflective surface so that the image viewed is only and entirely the image reflected from the convex reflective surface 12.

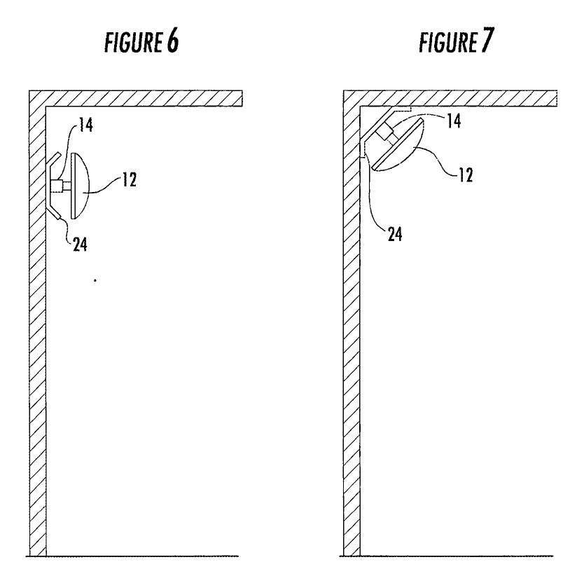

Referring now to FIGS. 6 and 7, the convex reflective surface 12 can be mounted to a wall as shown in FIG. 6, or a corner where the wall and ceiling join together as shown in FIG. 7. The mounting means 24 is designed for multiple mounting applications allowing a user to mount the convex reflective surface 12 in a variety of locations and positions. This allows the convex reflective surface 12 to be mounted in virtually any type of situation.

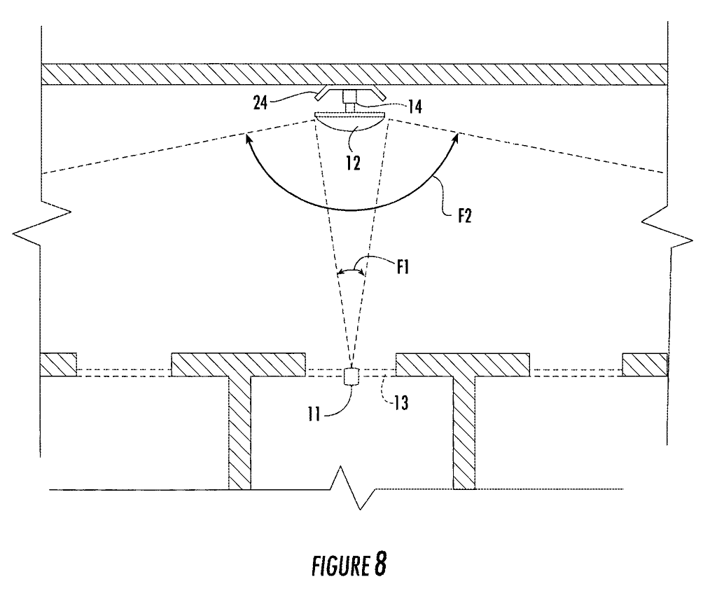

Referring now to FIG. 8, the combination of the viewing device 11 and the convex reflective surface 12 provides a user with an expanded viewing area. The combination of the viewing device 11 and convex reflective surface 12 provides a horizontal field of view of a selected area of nearly 180 degrees. This allows a clear view of the areas to the side of the vertical surface 13 that the viewing device 11 is mounted on. For example, the user can view the hallway and doors on either side of the vertical surface 13.

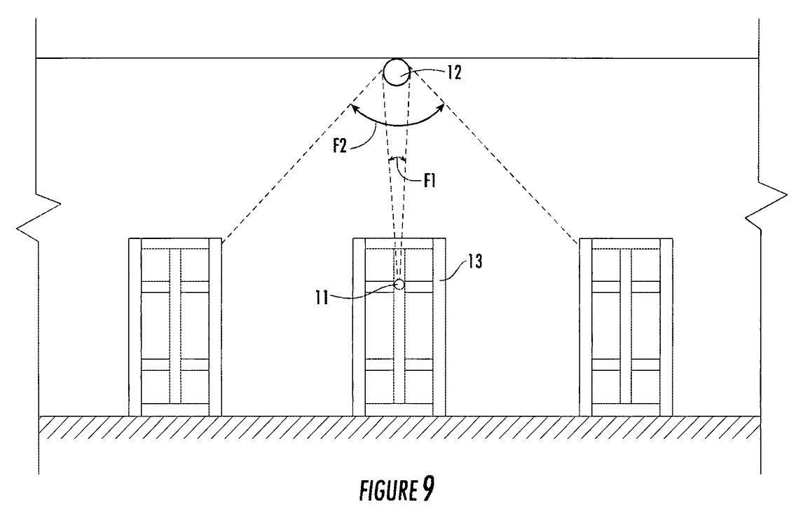

Referring now to FIG. 9, the vertical field of view of a selected area is sufficient to allow viewing all the way to the floor. The field of view in the vertical direction would allow a user to see someone who is stooping below the viewing device attached to the door.

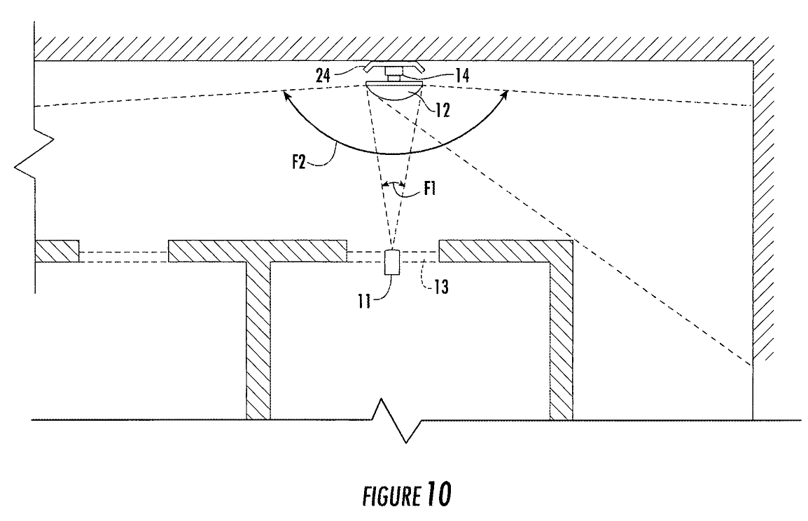

Referring now to FIG. 10, the combination of the viewing device 11 and the convex reflective surface 12 can also be used to see around corners. As is shown in FIG. 10, when the viewing device 11 is attached to a door 13 next to a corner, the field of view in the horizontal direction extends past the corner allowing a user to detect someone hiding around the corner.

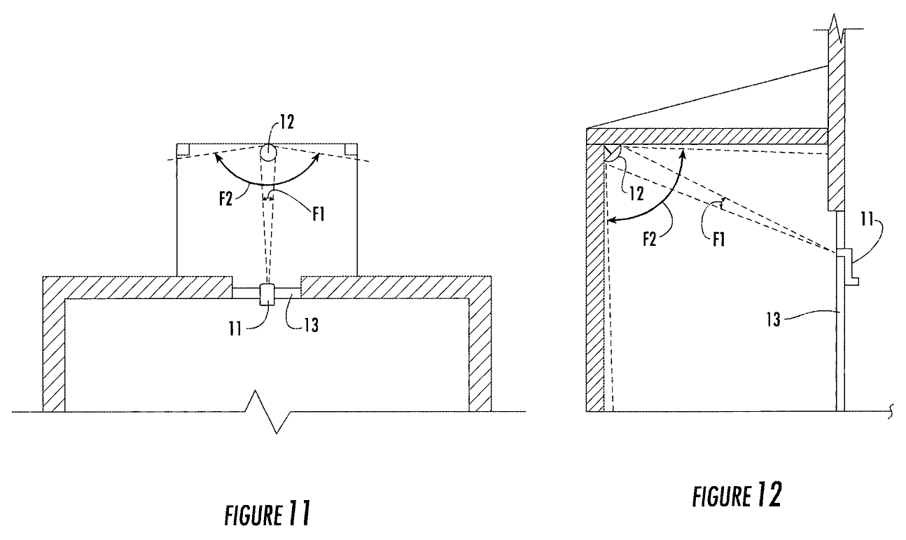

Referring now to FIGS. 11 and 12, the security viewing apparatus 10 can also be used on a vestibule/porch. FIG. 11 shows the field of view in the horizontal direction when the viewing device 11 and convex reflective surface 12 are used on a vestibule/porch. FIG. 12 shows the field of view in the vertical direction when the viewing device 12 and convex reflective surface 12 are used on a vestibule/porch.

Referring to FIGS. 1, 2, 3, 5, and 8-12, the combination of the viewing device 11 and convex reflective surface 12 provides an easy to operate security viewing apparatus 10. To use the security viewing apparatus 10, a user adjusts the inner vertical tube 15 in the vertical direction until the eyepiece 19 is at a height in relation to the user's eye. The user then looks through the eyepiece 19 and adjusts the first field of view F1 using the magnification/focus means 23 until the first field of view F1 is clear and only displays the second field of view F2 produced by the convex reflective surface 12.

A security viewing apparatus and method has been described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

1. A security viewing apparatus to provide a user with an expanded view of a selected area, comprising:
(a) a viewing device having a first field of view; and
(b) a convex reflective surface having a second field of view substantially greater than said first field of view, said reflective surface being positioned in a spaced-apart relationship to said viewing device and within said first field of view so as to reflect a view of said selected area to said viewer.

2. The security viewing apparatus according to claim 1, wherein said viewing device includes a magnification means for adjusting said first field of view with respect to said second field of view produced by said convex reflective surface.

3. The security viewing apparatus according to claim 1, wherein said viewing device includes a means for mounting said viewing device to a vertical surface and said convex reflective surface includes a means for mounting said convex reflective surface to a surface opposite said vertical surface.

4. The security viewing apparatus according to claim 3, wherein said viewing device includes a mounting flange for mounting said viewing device to said vertical surface.

5. The security viewing apparatus according to claim 1, wherein said viewing device includes an inner vertical tube mounted inside of an outer vertical tube for allowing a telescoping adjustment in a vertical direction, a horizontal tube attached to a top end of said outer vertical tube, and an eyepiece attached to a lower end of said inner vertical tube for viewing said first field of view.

6. A security viewing apparatus according to claim 5, wherein said inner vertical tube is adjustable in a vertical direction along a central vertical axis of said outer vertical tube for positioning said eyepiece in relation to a user's eye.

7. A security viewing apparatus according to claim 1, wherein said outer vertical tube and said inner vertical tube house a plurality of lenses and a plurality of reflective devices for providing a clear and adjustable said first field of view.

8. The security viewing apparatus according to claim 1 or 7, wherein the viewing device further comprises an adjustment means cooperating with said plurality of lenses for adjusting a focus and magnification of said viewing device.

9. The security viewing apparatus according to claim 1 or 5, wherein said eyepiece comprises at least one lens.

10. The security viewing apparatus according to claim 9, wherein said lens is made of a material selected from the group consisting of glass and plastic.

11. The security viewing apparatus according to claim 1 or 7, wherein said plurality of lenses are made of a material selected from the group consisting of glass and plastic.

12. The security viewing apparatus according to claim 1 or 7, wherein said reflective devices are selected from the group consisting of mirrors and prisms.

13. The security viewing apparatus according to claim 5, wherein said horizontal tube comprising an objective lens, protrudes through a vertical surface from an inner side of said vertical surface to an outer side of said vertical surface.

14. The security viewing apparatus according to claim 1, wherein the reflective surface has a convex cross-section.

15. The security viewing apparatus according to claim 1, wherein the reflective surface is rectangularly shaped.

16. The security viewing apparatus according to claim 1, wherein said reflective surface is defined as an arc of a sphere having a diameter of eight feet.

17. The security viewing apparatus according to claim 1, wherein said reflective surface is adjustable via an adjustable joint.

18. The method of installing a security viewing apparatus, comprising the steps:
(a) mounting a viewing device to a vertical surface by sliding a horizontal tube of said viewing device through a hole in said vertical surface and fastening said viewing device to said vertical surface via a mounting means;
(b) positioning a reflective surface along a surface opposite an outer side of said vertical surface for receiving a maximum second field of view from said reflective surface when looking through said viewing device;
(c) mounting said reflective surface to said surface opposite said outer side of said vertical surface using a mounting means; and
(d) adjusting said reflective surface using an adjustable joint to provide a maximum said second field of view.

19. The method of using a security viewing apparatus, comprising the steps:
(a) adjusting an inner vertical tube of a viewing device in a vertical direction for positioning an eyepiece attached to said inner vertical tube in relation to a user's eye;
(b) looking through said eyepiece for viewing a first field of view; and
(c) adjusting a focus and magnification of said viewing device by a magnification/focus means cooperating with a plurality of lenses to provide a clear first field of view displaying only a second field of view produced by a convex reflective surface.
